(19) United States
(12) Patent Application Publication
(10) Pub. No.: US 2004/0192409 A1
(43) Pub. Date: Sep. 30, 2004

(54) System and method for providing effective power management

(76) Inventors: Chi Fai Chan, Laguna City (HK); Kwok Hing Ngai, Kennedy Town (HK)

Correspondence Address: MICHAEL D. BEDNAREK, SHAW PITTMAN LLP, 1650 TYSONS BOULEVARD, MCLEAN, VA, 22102, US

(21) Appl. No.: 10/338,013

(22) Filed: Jan. 8, 2003

(51) Int. Cl. H04B 1/38

(52) U.S. Cl. 455/573; 455/575.1; 455/90.1

(57) ABSTRACT

A method for managing power in a cordless telephone is disclosed. The method includes an avoidance of operating all components of the cordless telephone concurrently. In one embodiment, a charging process of the handset is disabled during an RF transmission process between the base station and the handset.

BACKGROUND

1. Field of the Invention

The present invention relates generally to electrical power management and, more particularly, to electrical power management of a cordless telephone system.

2. Background of the Invention

A cordless telephone includes a base station and a handset. The base station requires a certain minimum amount of power from a power source, which is typically an AC source that is connected to the base station by a power cord. The minimum amount of power required by the base station is the sum of all current required to concurrently operate all components of the base station.

In a normal cordless telephone implementation, when the handset is placed on the cradle of the base station, in addition to start charging a battery of the handset, it is necessary for the base station to communicate with the handset through an RF link. The communication may be required for at least two reasons.

First, it is necessary to do a synchronization or channel searching. This is to avoid the handset and the base station from communicating with each other using different channels. A number of channel synchronization protocols can be employed to allow one unit (the base station or the handset) to scan all channels to find out which channel the other unit is using or prefer to use. This channel scanning task requires power be supplied to an RF transmitter in the base station.

The second reason for the RF communication is to verify and/or change a security code in both the handset and the base station. The security code is stored in each of the handset and the base station. Before a communication can start, the security code is transmitted by one unit and verified by the other unit via the RF link. This prevents the handset and the base station from using different security codes. Even if the security code matching is done manually, it is a usual practice to roll or change the security code every time the handset is placed on the cradle to prevent any one security code to remain the same for a long time.

Accordingly, in the typical cordless telephone implementation, the charging of the handset and the RF transmission take place concurrently, which results in a maximum power consumption situation. For example, in a cordless telephone, a total of 150 mA can be required to power the components as follows:

| | |
|---|---|
| RF transmitter current: | 30 mA |
| RF receiver current: | 60 mA |
| Microcomputer unit (MCU) and other: | 20 mA |
| Handset battery charger current: | 40 mA |

Even though the time required to complete the RF transmission is short, e.g., usually shorter than 200 ms, the power supply circuit must still have the ability to supply the maximum current of 150 mA. This means a larger and higher cost AC adaptor must be used. Alternatively, an expensive, larger capacitor will be required to store enough charge for this momentary large current requirement of the base station.

### SUMMARY OF THE INVENTION

The invention provides a system and method for managing power in a cordless telephone. One embodiment of the invention provides a method that avoids simultaneous operation of all components in the cordless telephone. Preferably, the method includes disabling one of a handset battery charger and an RF transmitter of the cordless telephone. Preferably, a charging process of a handset battery is disabled during an RF transmission between a handset and a base station of the cordless telephone. Preferably, the charging process of the handset battery is enabled after the RF transmission is completed. Alternatively, the RF transmission process between the handset and the base station of the cordless telephone is disabled during the handset battery charging process, and the RF transmission process is enabled after the handset battery charging process is completed.

### BRIEF DESCRIPTION OF THE DRAWINGS

FIG. 1 is a flowchart showing an exemplary process that can be used to implement an embodiment of the invention, in which power conservation can be done in more than one way.

FIG. 2 is a flowchart showing an exemplary process involved in another embodiment of the invention, in which power is not supplied to charge the handset battery when an RF transmission is required during the on-cradle period.

FIG. 3 is a flowchart showing an exemplary process involved in another embodiment of the invention, in which power is not supplied to the transmitter until the handset battery is fully charged.

FIG. 4 is a schematic diagram showing a cordless telephone in accordance with an embodiment of the invention.

### DETAILED DESCRIPTION OF THE INVENTION

The invention provides a system and method that reduces the power consumption of a cordless telephone. Preferred embodiments of the invention incorporate a method that avoids using all components of the cordless telephone at the same time.

In one embodiment of the invention in which the base station of the cordless telephone can be used to recharge the battery of the handset, the invention implements an algorithm to reduce the power consumption of the base station of the cordless telephone. For example, the invention can be configured to avoid concurrently (1) charging the handset and (2) providing an RF transmission between the handset and the base station. In this manner, a cordless telephone of the invention can use a lower power AC adaptor, which results in a reduction of operating cost of the cordless telephone. Likewise, the production cost of the cordless telephone can be reduced. Moreover, the cordless telephone is more environmental friendly due to its lower power consumption.

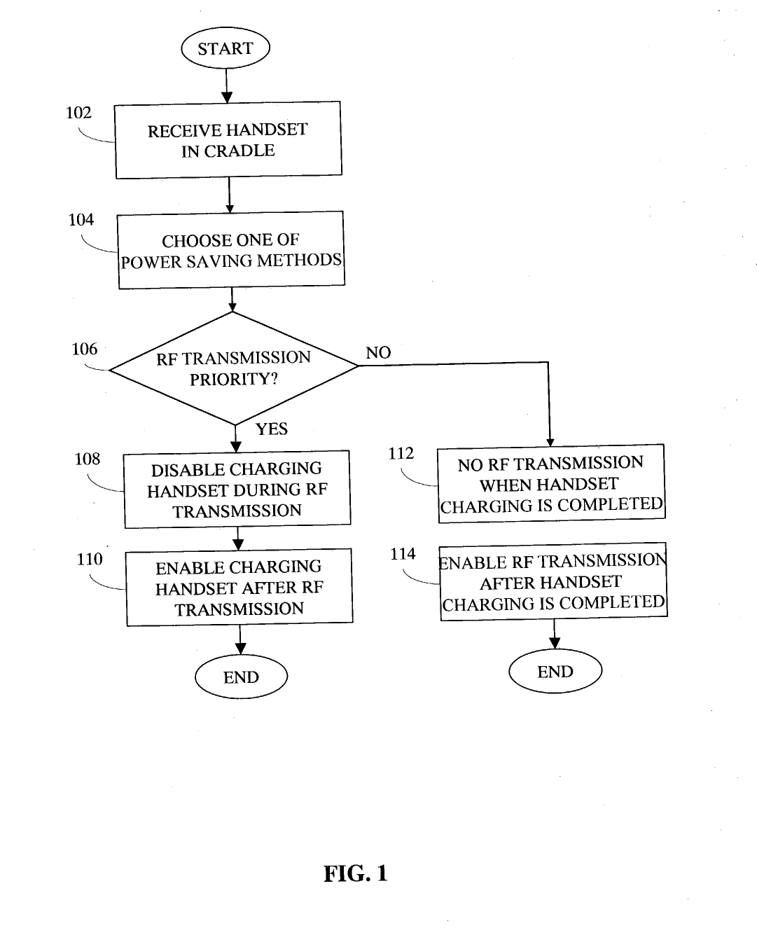

FIG. 1 is a flowchart showing an exemplary process that can be used to implement an embodiment of the invention, in which power conservation can be done in more than one way.

In step 102, the handset is received in the cradle of the base station.

In step 104, one of the power saving methods is chosen. For example, if the RF transmission process between the handset is given a priority over the charging process of the handset, the process goes to step 108. If, on the other hand, the charging process is given the priority, the process goes to step 112.

In step 108, the charging process is disabled during the RF transmission process.

In step 110, the charging process is enabled after the RF transmission is completed.

In step 112, the RF transmission process is disabled during the charging process.

In step 114, the RF transmission process is enabled after the charging process is completed.

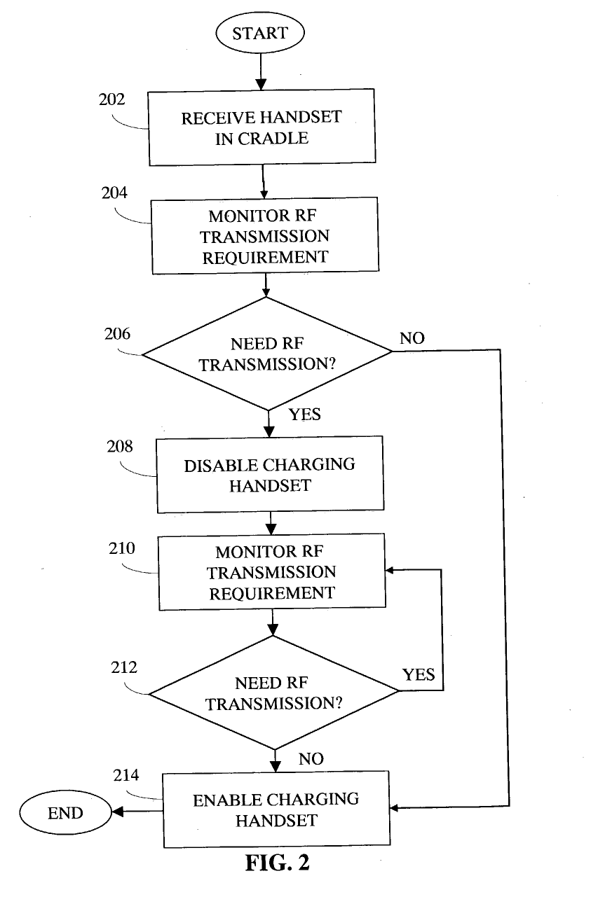

FIG. 2 is a flowchart showing an exemplary process involved in another embodiment of the invention, in which power is not supplied to charge the handset battery when an RF transmission is required during the on-cradle period.

In step 202, the handset is received at the cradle of the base station.

In step 204, the base station monitors an RF transmission requirement between the handset and the base station.

In step 206, if the RF transmission is needed, the process goes to step 208. Otherwise, the process goes to step 214.

In step 208, a charging process of the handset battery is disabled.

In step 210, an RF transmission process is enabled and the base station continues to monitor the RF transmission requirement.

In step 212, if the RF transmission process has ended, the process goes to step 214. The process repeats steps 210 and 212 for as long as the RF transmission requirement exists. The 210-212 loop usually last about 200 ms.

In step 214, the charging process is enabled.

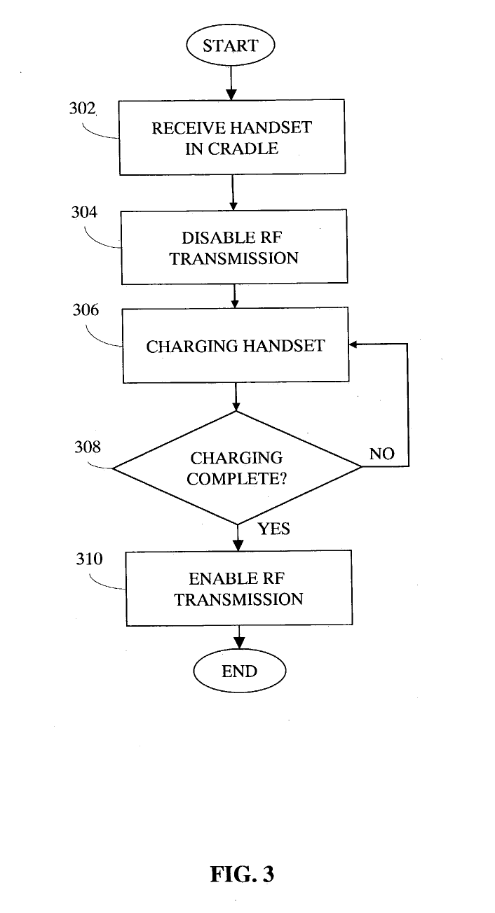

FIG. 3 is a flowchart showing an exemplary process involved in another embodiment of the invention, in which power is not supplied to the transmitter until the handset battery is fully charged.

In step 302, the handset is received at the cradle of the base station.

in step 304, an RF transmission process between the handset and the base station is disabled.

In step 306, the charging process of the handset battery is performed.

In step 308, it is determined whether the charging process has completed. If so, the process goes to step 310. Otherwise, the process returns to step 306.

In step 310, the RF transmission is enabled after the handset battery charging process is completed.

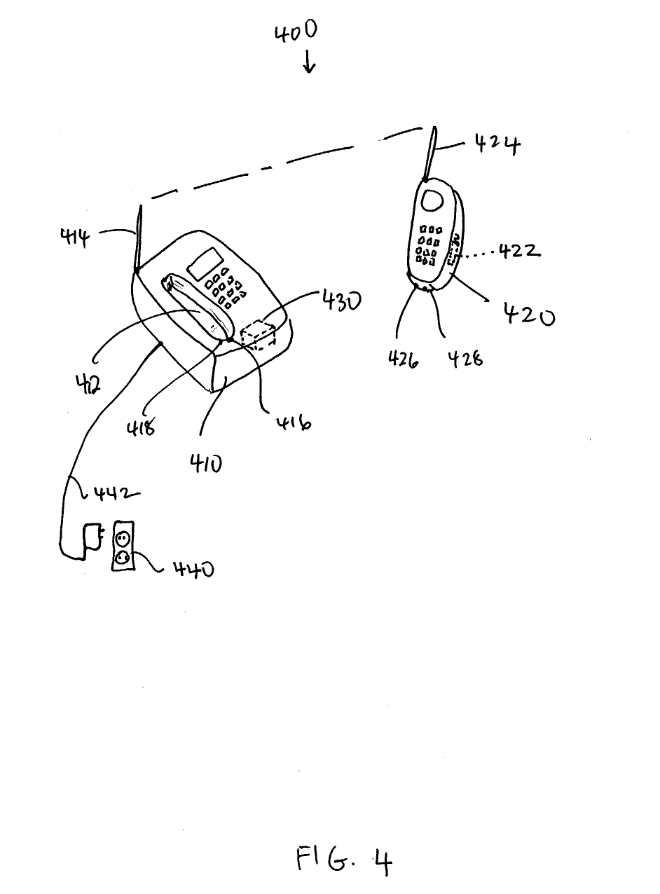

FIG. 4 is a schematic diagram of an embodiment of the invention.

Cordless telephone 400 includes base station 410, handset 420, and microprocessor 430. Microprocessor 430 is preferably residing at base station 410 as shown. However, microprocessor 430 can reside in handset 420 in another embodiment.

Base station 410 includes cradle 412, antenna 414, right contact 416, and left contact 418. Handset 420 includes battery 422, antenna 424, right contact 426, and left contact 428. Cradle 412 is configured to receive handset 420. When handset 420 is received at cradle 412, left contact 416 of base station 410 touches left contact 426 of handset 420. Similarly, right contact 418 of base station 410 touches right contact 428 of handset 420 when handset 420 is in cradle 412. Contacts 416, 418, 426, and 428 enable current from power source 440 be used to charge battery 422 of handset 420. Power cord 442 is used by base station 410 to receive current from power source 440.

Also, an RF transmission process takes place between base station 410 and handset 420 when handset 420 is in cradle 412. The RF transmission process is performed via antenna 414 and antenna 424.

Microprocessor 430 (also known as a microcomputer unit or MCU) is configured to execute an algorithm. The algorithm can include an exemplary process shown in one of FIGS. 1, 2, and 3. In other words, microprocessor 430 can be used to turn on or off components of cordless telephone 400. Specifically, microprocessor 430 can be configured to power on/off an RF transmitter, an RF receiver, and a handset battery charger. It is noted that since the RF communication process is very short (about 200 ms), there is no significant effect on the charging process.

Implementing any one of the embodiments disclosed above can save power consumption and power supply requirements of cordless telephone 400. For example, a typical cordless telephone may require a total of 150 mA as follows: 30 mA for the RF Transmitter current; 60 mA for the RF Receiver current; 20 mA for the MCU and other miscellaneous control units; and 40 mA for the charger current. In cordless telephone 400, however, a reduction of 40 mA can be realized because no concurrent charging of handset battery 422 is performed while the RF transmission is being processed. This results in about 27% reduction in power requirements.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for managing power in a cordless telephone comprising:
avoiding simultaneous operation of all components in the cordless telephone.

2. The method of claim 1, further comprising disabling one of a handset battery charger and an RF transmitter of the cordless telephone.

3. The method of claim 1, further comprising disabling a charging process of a handset battery during an RF transmission between a handset and a base station of the cordless telephone.

4. The method of claim 3, further comprising enabling the charging process of the handset battery after the RF transmission is completed.

5. The method of claim 1, further comprising disabling an RF transmission process between a handset and a base station of the cordless telephone during a handset battery charging process.

6. The method of claim 5, further comprising enabling the RF transmission process after the handset battery charging process is completed.

7. A method for managing power in a cordless telephone comprising:
receiving a handset at a base station of the cordless telephone;
monitoring an RF transmission requirement between the handset and the base station; and
disabling one of a battery charging process and an RF transmission process.

8. The method of claim 7, wherein the charging process is enabled after the RF transmission process is completed.

9. The method of claim 7, wherein the RF transmission process is enabled after the charging process is completed.

10. A method for managing power in a cordless telephone comprising:
receiving a handset at a base station of the cordless telephone;
disabling a battery charging process during an RF transmission process between the handset and the base station; and
enabling the charging process when the RF transmission process is completed.

11. A method for managing power in a cordless telephone comprising:
receiving a handset at a base station of the cordless telephone;
disabling an RF transmission process between the handset and the base station during a battery charging process; and
enabling the RF transmission process when the charging process is completed.

12. A cordless telephone comprising:
a handset;
a base station; and
a microprocessor configured to perform, but not concurrently, a battery charging process and an RF transmission process between the handset and the base station.

13. The cordless telephone of claim 12, wherein the charging process is performed after the RF transmission process is completed.

14. The cordless telephone of claim 12, wherein the charging process is disabled during the RF transmission process.

15. The cordless telephone of claim 12, wherein the RF transmission process is performed after the charging process is completed.

16. A cordless telephone comprising:
a handset;
a base station; and
a microprocessor configured to perform a charging process of the handset after an RF transmission process between the handset and the base station is completed.

17. The cordless telephone of claim 16, wherein the microprocessor is configured to disable the charging process during the RF transmission process.

18. The cordless telephone of claim 16, wherein the microprocessor is configured to enable the charging process when the RF transmission process is not required.

19. A cordless telephone comprising:
a handset;
a base station; and
a microprocessor configured to disable a charging process of the handset during an RF transmission process between the handset and the base station.

20. The cordless telephone of claim 19, wherein the microprocessor is configured to enable the charging process after the RF transmission process is completed.
